(19) United States
(12) Patent Application Publication
(10) Pub. No.: US 2025/0115170 A1
(43) Pub. Date: Apr. 10, 2025

(54) VEHICLE SEAT POSITION ADJUSTMENT DEVICE

(71) Applicants: Hyundai Motor Company, Seoul (KR); Kia Corporation, Seoul (KR); Faurecia Korea, Ltd., Yongin (KR); Hyundai Transys Inc., Seosan (KR)

(72) Inventors: Sang Soo Lee, Hwaseong (KR); Ho Suk Jung, Hwaseong (KR); Deok Soo Lim, Hwaseong (KR); Sang Do Park, Seoul (KR); Chan Ho Jung, Gunpo (KR); Mu Young Kim, Osan (KR); Jin Sik Kim, Yongin (KR); Youn Myung Joo, Yongin (KR); Dong Gyu Shin, Hwaseong (KR); Taek Jun Nam, Yongin (KR); Gun Chu Park, Hwaseong (KR)

(21) Appl. No.: 18/410,067

(22) Filed: Jan. 11, 2024

(30) Foreign Application Priority Data
Oct. 6, 2023 (KR) 10-2023-0133366

(51) Int. Cl. B60N 2/10; B60N 2/02

(52) U.S. Cl. CPC B60N 2/10; B60N 2/02246

(57) ABSTRACT

A vehicle seat position adjustment device is configured to stably perform a tilting operation of a seat cushion by performing an operation of rotating a first tilting link hinged to a gear box in a standing direction of a first tilting link while the gear box is moved rearwards along a lead screw, an operation of pushing up a second tilting link hinged to the first tilting link while the first tilting link is rotated in a standing direction, and an operation of allowing the second tilting link to push up a front end of a seat cushion frame. The vehicle seat position adjustment device may achieve a relaxation comfort posture by tilting the seat cushion and simultaneously reclining a seatback connected to the seat cushion rearwards.

### CROSS-REFERENCE TO RELATED APPLICATION

This application claims under 35 U.S.C. § 119 (a) the benefit of Korean Patent Application No. 10-2023-0133366, filed on Oct. 6, 2023, the entire contents of which are incorporated herein by reference.

### BACKGROUND

### (a) Technical Field

The present disclosure relates to a vehicle seat position adjustment device, more particularly, to the vehicle seat position adjustment device configured to allow a seat cushion to be tilted and a seatback to be reclined simultaneously, in order to achieve a relaxation comfort posture of a vehicle seat.

### (b) Description of the Related Art

In general, a vehicle seat includes basic components such as a seat cushion configured to allow the lower body of a passenger to be seated thereon, a seatback configured to support the upper body of a passenger, and a headrest configured to support the neck and the head of a passenger. In addition to the basic components, various seat position adjustment devices and convenience devices are installed inside and outside the vehicle seat.

Further, it is required to mount a seat mechanism capable of implementing a relaxation comfort posture in an autonomous vehicle and an electric vehicle. For example, when an autonomous vehicle travels a long distance, the seat mechanism enables a driver to comfortably rest or sleep. Additionally, when it takes a long time to charge an electric vehicle, the seat mechanism enables a driver to comfortably rest during charging of the electric vehicle.

Here, the above-mentioned relaxation comfort posture refers to a posture that maximally distributes body pressure of a passenger in a state in which the passenger is seated on the seat, thereby allowing the passenger to feel comfortable as if in a weightless state.

For example, as shown in FIG. 1 (RELATED ART), the relaxation comfort posture is implemented by performing a tilting operation of a seat cushion and a reclining operation of a seatback so as to achieve an angle of approximately 105° to 120° between the passenger's lower body supported by the seat cushion and the passenger's upper body supported by the seatback.

Meanwhile, a seat cushion tilting device of the related art may tilt a seat cushion at a predetermined angle to implement a relaxation comfort posture. However, this tilt operation may cause deterioration in coupling force between the seat cushion tilting device and a seat cushion frame in the seat cushion. Accordingly, a gap is generated at a connection portion between the seat cushion tilting device and the seat cushion frame, and the gap causes various problems such as shaking, vibration, and torsional deformation.

In other words, since a motor and a lead screw adopted to perform seat cushion tilting are connected to only one side of the seat cushion frame, the seat cushion frame may be deformed to one side due to passenger load and vehicle vibration acting on the seat cushion frame. Accordingly, there is a problem in that a gap may be generated at a connection portion between the seat cushion tilting device and the seat cushion frame, and as such, shaking, vibration, and the like may occur.

The above information disclosed in this Background section is only for enhancement of understanding of the background of the disclosure, and therefore it may contain information that does not form the prior art that is already known in this country to a person of ordinary skill in the art.

### SUMMARY

The present disclosure provides a vehicle seat position adjustment device capable of stably performing a tilting operation of a seat cushion by performing an operation of rotating a tilting link hinged to a gear box in the standing direction of the tilting link while the gear box is moved rearwards along a lead screw, an operation of pushing up a front link hinged to the tilting link while the tilting link is rotated in the standing direction, and an operation of allowing the front link to push up the front end of a seat cushion frame. The vehicle seat position adjustment device may reliably achieve a relaxation comfort posture by tilting the seat cushion and reclining a seatback connected to the seat cushion rearwards simultaneously.

In one aspect, the present disclosure provides a vehicle seat position adjustment device including a first fixing bracket and a second fixing bracket respectively mounted on front ends of a pair of seat rails, a seat cushion frame hinged to side frames respectively mounted on rear ends of the seat rails, a first tilting link hinged to the first fixing bracket, a second tilting link hinged to the second fixing bracket, a first front link having one end hinged to the first tilting link and another end hinged to a first front end of the seat cushion frame, a second front link having one end hinged to the second tilting link and another end hinged to a second front end of the seat cushion frame, and a driving device connected to the first tilting link and the second tilting link and configured to transmit, to the first tilting link and the second tilting link, rotational force to tilt the seat cushion frame.

In a preferred embodiment, the driving device may include a first gear box hinged to the first tilting link and configured to transmit the rotational force to the first tilting link, a first lead screw inserted into and coupled to the first gear box in a forward-and-rearward direction so as to move the first gear box forwards and rearwards, wherein the first lead screw may have a rear end hinged to a connection frame configured to connect the pair of seat rails, a second gear box hinged to the second tilting link and configured to transmit the rotational force to the second tilting link, a second lead screw inserted into and coupled to the second gear box in the forward-and-rearward direction so as to move the second gear box forwards and rearwards, wherein the second lead screw may have a rear end hinged to the connection frame configured to connect the pair of seat rails, and a double-shaft motor connected to the first gear box and the second gear box so as to transmit the rotational force to the first gear box and the second gear box.

In another preferred embodiment, the first tilting link may have a 1-1 hinge end formed at an upper end thereof and hinged to the first gear box, a 1-2 hinge end formed at a front end thereof and hinged to the first front link, and a 1-3 hinge end formed at a lower end thereof and hinged to the first fixing bracket.

In still another preferred embodiment, the second tilting link may have a 2-1 hinge end formed at an upper end thereof and hinged to the second gear box, a 2-2 hinge end formed at a front end thereof and hinged to the second front link, and a 2-3 hinge end formed at a lower end thereof and hinged to the second fixing bracket.

In yet another preferred embodiment, the first lead screw passing through the first gear box and the second lead screw passing through the second gear box may have stopper nuts respectively coupled to front ends thereof, wherein each of the stopper nuts may limit a maximum forward distance of the first gear box and the second gear box.

In still yet another preferred embodiment, the double-shaft motor may have a support plate mounted thereon, wherein the support plate may be connected to the first gear box and the second gear box and supports the double-shaft motor.

In a further preferred embodiment, the first gear box may have a first cover bracket mounted on a circumferential portion thereof, wherein the first cover bracket may include an outer plate hinged to an upper end of the first tilting link and a connection end coupled to one end of the support plate.

In another further preferred embodiment, the second gear box may have a second cover bracket mounted on a circumferential portion thereof, wherein the second cover bracket may include an outer plate hinged to an upper end of the second tilting link and a connection end coupled to another end of the support plate.

In still another further preferred embodiment, the connection frame may have hinge brackets mounted thereon and respectively hinged to the rear end of the first lead screw and the rear end of the second lead screw.

In yet another further preferred embodiment, a flexible cable may be adopted for a first rotation transmission shaft and a second rotation transmission shaft, wherein the first rotation transmission shaft may connect one output part of the double-shaft motor to an input part of the first gear box, and the second rotation transmission shaft may connect the other output part of the double-shaft motor to an input part of the second gear box

A vehicle seat may include vehicle seat adjustment device.

A vehicle may include the vehicle seat adjustment device.

In another aspect, a method of operating a vehicle seat position adjustment device may include steps of: providing a vehicle seat position adjustment device comprising a first fixing bracket and a second fixing bracket respectively mounted on front ends of a pair of seat rails, a seat cushion frame hinged to side frames respectively mounted on rear ends of the seat rails, a tilting link comprising a first tilting link hinged to the first fixing bracket and a second tilting link hinged to the second fixing bracket, and a driving device connected to the first tilting link and the second tilting link and configured to transmit, to the first tilting link and the second tilting link, rotational force to tilt the seat cushion frame; performing a tilting operation of a seat cushion by rotating a tilting link hinged to a gear box in a standing direction of the tilting link while the gear box is moved rearwards along a lead screw; pushing up a front link hinged to the tilting link while the tilting link is rotated in the standing direction, and allowing the front link to push up a front end of the seat cushion frame.

In additional aspects, vehicles are provided that comprises a seat and seat assembly as disclosed herein.

In certain aspects, a present vehicle may be an autonomous vehicle.

In a fully autonomous vehicle or system, the vehicle may perform all driving tasks under all conditions and little or no driving assistance is required a human driver. In semi-autonomous vehicle, for example, the automated driving system may perform some or all parts of the driving task in some conditions, but a human driver regains control under some conditions, or in other semi-autonomous systems, the vehicle's automated system may oversee steering and accelerating and braking in some conditions, although the human driver is required to continue paying attention to the driving environment throughout the journey, while also performing the remainder of the necessary tasks.

In certain embodiments, the present systems and vehicles may be fully autonomous. In other certain embodiments, the present systems and vehicles may be semi-autonomous.

Other aspects and preferred embodiments of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 (RELATED ART) is a schematic diagram showing an example in which a vehicle seat may be adjusted to a relaxation comfort posture;

FIG. 2 is an exploded perspective view showing a vehicle seat position adjustment device according to the present disclosure;

FIG. 3 is an assembled perspective view showing the vehicle seat position adjustment device according to the present disclosure;

FIG. 4 is a perspective view showing a state before a tilting operation of the vehicle seat position adjustment device according to the present disclosure;

FIG. 5 is a perspective view showing a state after the tilting operation of the vehicle seat position adjustment device according to the present disclosure;

FIG. 6 is a side view showing the state before the tilting operation of the vehicle seat position adjustment device according to the present disclosure;

FIG. 7 is a side view showing the state after the tilting operation of the vehicle seat position adjustment device according to the present disclosure; and

FIG. 8 is a side view showing a state after height increase adjustment of the vehicle seat position adjustment device according to the present disclosure.

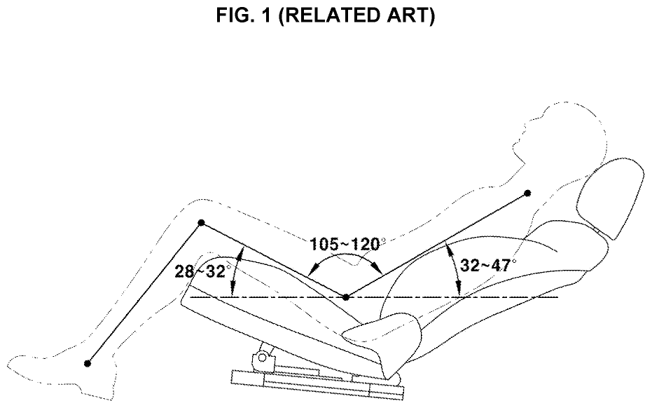

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Specific structural or functional descriptions made in connection with the embodiments of the present disclosure are merely illustrative for the purpose of describing embodiments according to the concept of the present disclosure, and the embodiments according to the concept of the present disclosure may be implemented in various forms. Further, it will be understood that the present description is not intended to limit the disclosure to the embodiments. On the contrary, the disclosure is intended to cover not only the embodiments, but also various alternatives, modifications, equivalents and other embodiments, which may be included within the spirit and scope of the disclosure as defined by the appended claims.

Meanwhile, in the present disclosure, terms such as “first” and/or “second” may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the present disclosure.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that other components are not present therebetween. Other expressions for the description of relationships between components, that is, “between” and “directly between” or “adjacent to” and “directly adjacent to”, should be interpreted in the same manner.

The same reference numerals represent the same components throughout the specification. Additionally, the terms in the specification are used merely to describe embodiments, and are not intended to limit the present disclosure. In this specification, an expression in a singular form also includes the plural sense, unless clearly specified otherwise in context.

Hereinafter, the present disclosure will be described in detail with reference to the accompanying drawings.

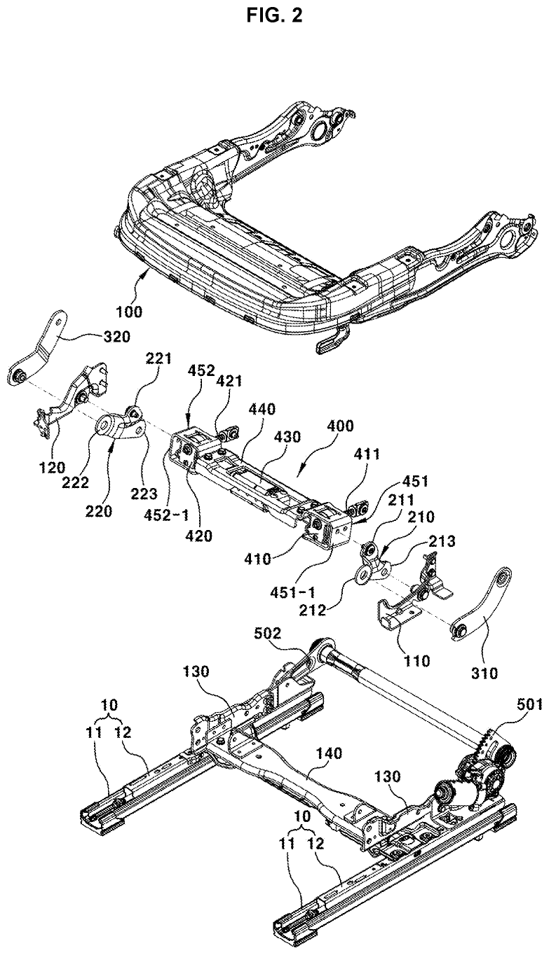

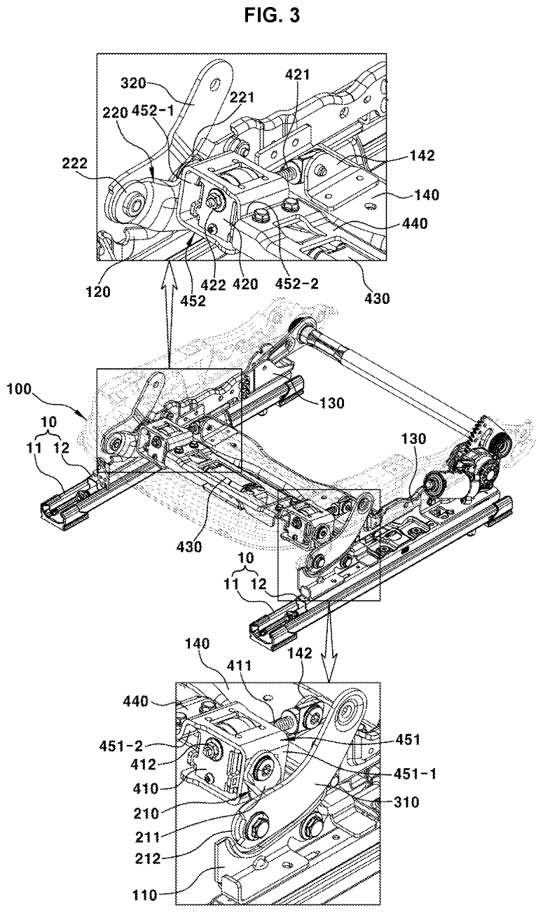

FIGS. 2 and 3 are perspective views showing a vehicle seat position adjustment device according to the present disclosure, and reference numeral 10 indicates a seat rail.

Preferably a pair of seat rails 10 are provided, where each of the seat rails 10 is substantially the same. The seat rails 10 are mounted on a floor panel, which is the interior floor of a vehicle. Further, the seat rails 10 are disposed to be spaced apart from each other in a left-and-right direction.

Each of the seat rails 10 includes a fixed rail 11 fixedly mounted on the floor panel and a moving rail 12 coupled to the fixed rail 11 and configured to be movable forwards and rearwards. A forward-and-rearward position of a seat may be adjusted by moving the moving rail 12 forwards or rearwards along the fixed rail 11.

A first fixing bracket 110 and a second fixing bracket 120 are respectively mounted on the front ends of the pair of seat rails 10.

Preferably, the first fixing bracket 110 and the second fixing bracket 120 are respectively mounted on the front ends of the moving rails 12 in the pair of seat rails 10.

A side frame 130 is mounted on the rear end of the moving rail 12 of each of the seat rails 10, and the rear end of a seat cushion frame 100 is hinged to the side frame 130.

A first tilting link 210 adopted to tilt the seat cushion frame 100 is rotatably hinged to the first fixing bracket 110, and a second tilting link 220 adopted to tilt the seat cushion frame 100 is rotatably hinged to the second fixing bracket 120.

Additionally, a first front link 310 adopted to tilt the seat cushion frame 100 connects the first tilting link 210 to the seat cushion frame 100, and a second front link 320 adopted to tilt the seat cushion frame 100 connects the second tilting link 220 to the seat cushion frame 100.

More particularly, the lower end of the first front link 310 is hinged to the first tilting link 210, and the upper end of the first front link 310 is hinged to a first front end of the seat cushion frame 100. Further, the lower end of the second front link 320 is hinged to the second tilting link 210, and the upper end of the second front link 320 is hinged to a second front end of the seat cushion frame 100.

Here, a driving device 400 is connected to the first tilting link 210 and the second tilting link 220, in which the driving device 400 transmits, to the first tilting link 210 and the second tilting link 220, rotational force to tilt the seat cushion frame 100.

Accordingly, the first tilting link 210 and the second tilting link 220 receive rotational force from the driving device 400 so as to be rotated forwards or rearwards, thereby performing a function of tilting the seat cushion frame 100.

To this end, the first tilting link 210 has a 1-1 hinge end 211 formed at the upper end thereof and hinged to a first gear box 410 of the driving device 400, a 1-2 hinge end 212 formed at the front end thereof and hinged to the first front link 310, and a 1-3 hinge end 213 formed at the lower end thereof and hinged to the first fixing bracket 110.

In addition, the second tilting link 220 has a 2-1 hinge end 221 formed at the upper end thereof and hinged to a second gear box 420 of the driving device 400, a 2-2 hinge end 222 formed at the front end thereof and hinged to the second front link 320, and a 2-3 hinge end 223 formed at the lower end thereof and hinged to the second fixing bracket 120.

Particularly, the driving device 400 includes the first gear box 410 hinged to the first tilting link 210 so as to transmit rotational force to the first tilting link 210, the second gear box 420 hinged to the second tilting link 220 so as to transmit rotational force to the second tilting link 220, and a double-shaft motor 430 connected to the first gear box 410 and the second gear box 420 so as to transmit rotational force to the first gear box 410 and the second gear box 420.

Additionally, in order to perform sliding movement of the first gear box 410 in the forward-and-rearward direction, a first lead screw 411 is inserted into and coupled to the first gear box 410 in the forward-and-rearward direction, and the rear end of the first lead screw 411 is hinged to a connection frame 140 configured to connect the pair of seat rails 10.

Furthermore, in order to perform sliding movement of the second gear box 420 in the forward-and-rearward direction, a second lead screw 421 is inserted into and coupled to the second gear box 420 in the forward-and-rearward direction, and the rear end of the second lead screw 421 is hinged to the connection frame 140 configured to connect the pair of seat rails.

Preferably, the connection frame 140 has hinge brackets 142 mounted thereon and respectively hinged to the rear end of the first lead screw 411 and the rear end of the second lead screw 421.

Here, although the interior of the first gear box 410 and the second gear box 420 is not shown, the first gear box 410 and the second gear box 420 have typical gear trains respectively installed therein and configured to respectively move the first gear box 410 and the second gear box 420 forwards or rearwards along the first lead screw 411 and the second lead screw 421.

In this case, the front end of the first lead screw 411 coupled through the first gear box 410 and the front end of the second lead screw 421 coupled through the second gear box 420 are respectively coupled to stopper nuts 412 and 422 configured to limit the maximum forward distance of the first gear box 410 and the second gear box 420.

Meanwhile, the double-shaft motor 430 has a support plate 440 mounted thereon and configured to support the double-shaft motor 430. One end of the support plate 440 is connected to the first gear box 410, and another end of the support plate 440 is connected to the second gear box 420.

To this end, the first gear box 410 has a first cover bracket 451 mounted on the circumferential portion thereof, in which the first cover bracket 451 includes an outer plate 451-1 hinged to the 1-1 hinge end 211 of the first tilting link 210 and a connection end 451-2 coupled to one end of the support plate 440. Additionally, the second gear box 420 has a second cover bracket 452 mounted on the circumferential portion thereof, in which the second cover bracket 452 includes an outer plate 452-1 hinged to the 2-1 hinge end 221 of the second tilting link 220 and a connection end 452-2 coupled to another end of the support plate 440.

Meanwhile, a flexible cable is adopted for a first rotation transmission shaft 431 connecting one output part of the double-shaft motor 430 to the input part of the first gear box 410, and a second rotation transmission shaft 432 connecting the other output part of the double-shaft motor 430 to the input part of the second gear box 420.

Therefore, even if vehicle body vibration and load act on the seat, rotational force of the double-shaft motor 430 may be stably transmitted to the first gear box 410 and the second gear box 420 through the first rotation transmission shaft 431 and the second rotation transmission shaft 432, which are flexible cables.

Hereinafter, a description will be given as to an operation flow of the vehicle seat position adjustment device of the present disclosure configured as described above.

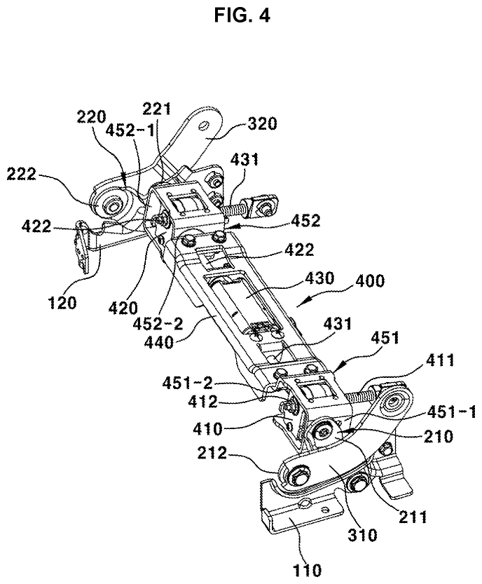

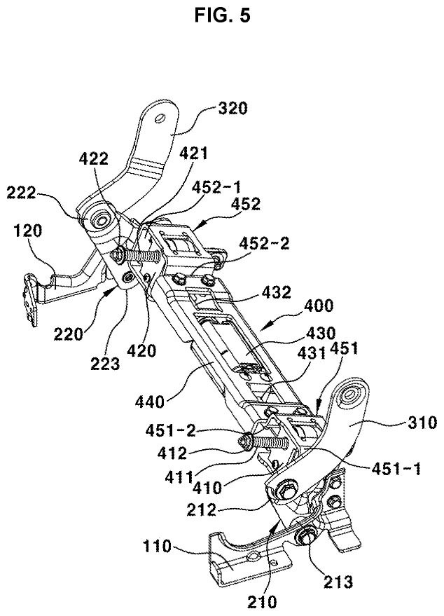

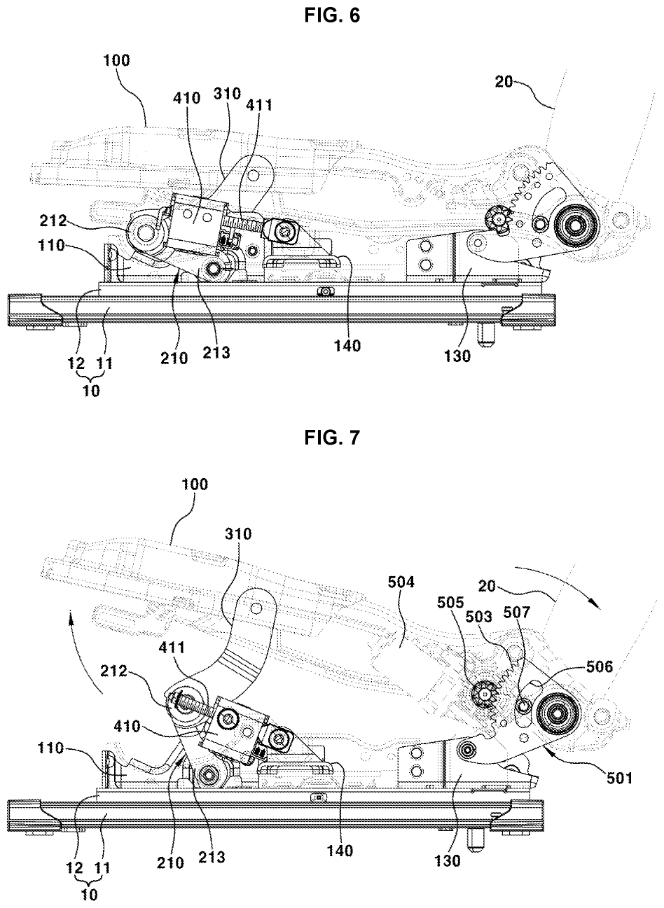

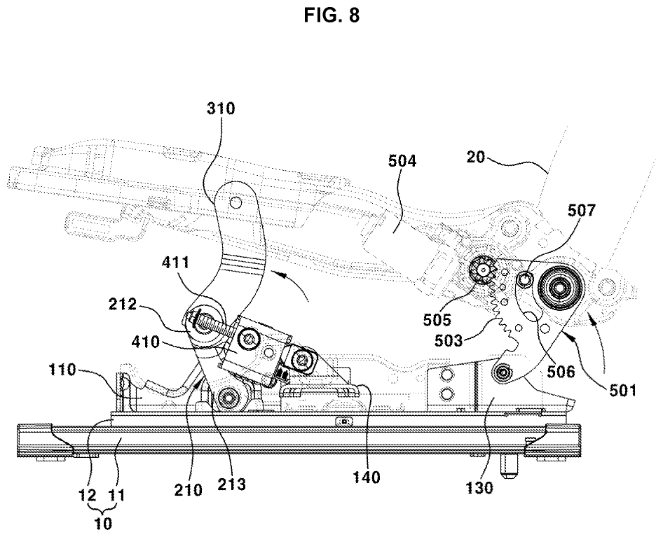

FIGS. 4 and 6 show a state before the tilting operation of the vehicle seat position adjustment device according to the present disclosure, and FIGS. 5 and 7 show a state after the tilting operation of the vehicle seat position adjustment device according to the present disclosure.

Referring to FIGS. 4 and 6, the front end of the seat cushion frame 100 may be lowered around the rear end of the seat cushion frame 100 hinged to the side frame 130, thereby enabling the seat cushion frame 100 to be placed in a state before tilting.

In addition, in the state before tilting of the seat cushion frame 100, the first gear box 410 is located so as to maximally move forwards along the first lead screw 411, and the second gear box 420 is also located so as to maximally move forwards along the second lead screw 421.

Further, in the state before tilting of the seat cushion frame 100, the first tilting link 210 is maximally rotated forwards around a hinge coupling point with the first fixing bracket 110, thereby being placed in a state of being laid down, and the second tilting link 220 is also maximally rotated forwards around a hinge coupling point with the second fixing bracket 120, thereby being placed in a state of being laid down.

Additionally, in the state before tilting of the seat cushion frame 100, the first front link 310 is maximally lowered with a predetermined inclination, thereby being placed in a state of being laid down, and the second front link 320 is also maximally lowered with a predetermined inclination, thereby being placed in a state of being laid down.

In the state before tilting of the seat cushion frame 100 as described above, as shown in FIGS. 5 and 7, a tilting operation may be performed to move the front end of the seat cushion frame 100 upwards around the rear end of the seat cushion frame 100 hinged to the side frame 130.

To this end, when power is first applied to the dual-shaft motor 430 of the driving device 400, rotational force of the dual-shaft motor 430 is transmitted to the first gear box 410 through the first rotation transmission shaft 431 and is simultaneously transmitted to the second gear box 420 through the second rotation transmission shaft 432.

Subsequently, the first gear box 410 is moved rearwards along the first lead screw 411 by a normal gear train (not shown) installed in the first gear box, and simultaneously, the second gear box 420 is moved rearwards along the second lead screw 421 by a normal gear train (not shown) installed in the second gear box.

Continuously, when the first gear box 410 is moved rearwards, the first tilting link 210 hinged to the outer plate 451-1 of the first cover bracket 451 mounted on the circumferential portion of the first gear box 410 is rotated rearwards around the hinge coupling point with the first fixing bracket 110, thereby being placed in the standing state.

Here, when the second gear box 420 is moved rearwards, the second tilting link 220 hinged to the outer plate 452-1 of the second cover bracket 452 mounted on the circumferential portion of the second gear box 420 is also rotated rearwards around the hinge coupling point with the second fixing bracket 120, thereby being placed in the standing state.

Thereafter, when the first tilting link 210 is rotated to stand toward the rear, the first tilting link 210 pushes up the first front link 310 hinged between the first tilting link 210 and the seat cushion frame 100, thereby allowing the first front link 310 to be in the standing state. Here, when the second tilting link 220 is rotated to stand toward the rear, the second tilting link 220 pushes up the second front link 320 hinged between the second tilting link 220 and the seat cushion frame 100, thereby allowing the second front link 320 to be in the standing state.

Accordingly, the first front link 310 pushes up the front end of one side of the seat cushion frame 100, and simultaneously, the second front link 320 pushes up the front end of the other side of the seat cushion frame 100, thereby making it possible to perform the tilting operation of enabling the front end of the seat cushion frame 100 to be moved upwards around the rear end of the seat cushion frame 100 hinged to the side frame 130.

In this case, when the front end of the seat cushion frame 100 is moved upwards around the rear end of the seat cushion frame 100 hinged to the side frame 130, and the tilting operation of the seat cushion is performed, an operation of reclining the seatback 20 connected to the seat cushion rearwards is simultaneously performed, as shown in FIG. 7, thereby implementing a relaxation comfort posture.

In this manner, a first front end of the seat cushion frame 100 is tilted by the first gear box 410, the first lead screw 411, the first tilting link 210, and the first front link 310, and simultaneously, a second front end of the seat cushion frame 100 is tilted by the second gear box 420, the second lead screw 421, the second tilting link 220, and the second front link 320, thereby making it possible to stably perform the tilting operation of the seat cushion frame without vibration or deformation. In addition, when the seat cushion is tilted and the seatback connected to the seat cushion is reclined rearwards, a relaxation comfort posture may be easily achieved.

Meanwhile, as shown in FIG. 8, in order to adjust the height of a seat, the vehicle seat position adjustment device according to the present disclosure further includes a first height adjustment link 501, a second height adjustment link 502, a sector gear 503, a height adjustment motor 504, and a pinion 505.

The upper ends of the first and second height adjustment links 501 and 502 are respectively hinged to the opposite rear ends of the seat cushion frame 100, and the lower ends of the first and second height adjustment links 501 and 502 are respectively hinged to the opposite rear ends of the side frame 130.

The sector gear 503 is formed at the front portion of the upper end of the first height adjustment link 501.

The height adjustment motor 504 is mounted on one rear end of the seat cushion frame 100, and the pinion 505 engaged with the sector gear 503 is mounted on the output shaft of the height adjustment motor 504.

In addition, a curved slot 506 is formed to penetrate the upper portion of the first height adjustment link 501 so as to limit a lifting distance of the seat cushion frame 100, and the seat cushion frame 100 has a guidance pin 507 formed to protrude from one rear end thereof and movably inserted into the curved slot 506.

Therefore, when the first front link 310 and the second front link 320 are placed upwards as described above, the height of the front end of the seat cushion frame 100 increases. In this state, when the height adjustment motor 504 is rotationally driven in one direction, the pinion 505 connected to the output shaft of the height adjustment motor 504 is moved to the upper portion of the sector gear 503 formed on the first height adjustment link 501, thereby increasing the height of the rear end of the seat cushion frame 100.

That is, when the pinion 505 is moved to the upper portion of the sector gear 503 formed on the first height adjustment link 501, the height adjustment motor 504 connected to the pinion 505 and the rear end of the seat cushion frame 100 having the height adjustment motor 504 mounted thereon may also be moved upwards.

Here, when the rear end of the seat cushion frame 100 is moved upwards, the guidance pin 507 formed in the seat cushion frame 100 is moved to the uppermost portion of the curved slot 506 formed in the first height adjustment link 501. Thereafter, the first height adjustment link 501 is pulled forwards.

Subsequently, when the guidance pin 507 formed on the seat cushion frame 100 is moved to the uppermost portion of the curved slot 506 so as to pull the first height adjustment link 501 forwards, as shown in FIG. 8, the first height adjustment link 501 is rotated forwards (is rotated counterclockwise based on the direction in FIG. 6) so as to be erected vertically, thereby lifting the rear end of the seat cushion frame 100.

Therefore, when the first front link 310 and the second front link 320 are erected vertically as described above, the rear end of the seat cushion frame 100 is lifted in the state in which the height of the front end of the seat cushion frame 100 increases, thereby making it possible to increase the height of the entire seat.

As is apparent from the above description, the present disclosure provides the following effects.

First, one motor, two gear boxes, and two lead screws are adopted to perform a tilting operation of raising and lowering the front end of a seat cushion frame, thereby making it possible to stably perform the tilting operation of a seat cushion without vibration or deformation. That is, a first front end of the seat cushion frame is tilted by a first gear box, a first lead screw, a first tilting link, and a first front link, and a second front end of the seat cushion frame is tilted by a second gear box, a second lead screw, a second tilting link, and a second front link, thereby making it possible to stably perform the tilting operation of the seat cushion frame without vibration or deformation.

Second, when a seatback connected to the seat cushion is reclined rearwards with the tilting operation of the seat cushion, a relaxation comfort posture may be easily achieved.

Third, a first front end of the seat cushion frame is restrained by the first gear box, the first lead screw, the first tilting link, and the first front link, and a second front end of the seat cushion frame is restrained by the second gear box, the second lead screw, the second tilting link, and the second front link, thereby making it possible to prevent the seat cushion frame from being twisted to one side and deformed in the event of vehicle collision. In this manner, passenger safety may be reliably secured.

Although the present disclosure has been described in detail with reference to preferred embodiments thereof, the scope of the present disclosure is not limited to the above-described embodiment. Further, it will be appreciated by those skilled in the art that changes may be made in these embodiments without departing from the principles and spirit of the disclosure, the scope of which is defined in the appended claims and equivalents thereto.

What is claimed is:

1. A vehicle seat position adjustment device comprising:
a first fixing bracket and a second fixing bracket respectively mounted on front ends of a pair of seat rails;
a seat cushion frame hinged to side frames respectively mounted on rear ends of the seat rails;
a first tilting link hinged to the first fixing bracket;
a second tilting link hinged to the second fixing bracket; and
a driving device connected to the first tilting link and the second tilting link and configured to transmit, to the first tilting link and the second tilting link, rotational force to tilt the seat cushion frame.

2. The vehicle seat position adjustment device of claim 1, wherein the driving device comprises:
a first gear box hinged to the first tilting link and configured to transmit the rotational force to the first tilting link;
a first lead screw inserted into and coupled to the first gear box in a forward-and-rearward direction so as to move the first gear box forwards and rearwards, wherein the first lead screw has a rear end hinged to a connection frame configured to connect the pair of seat rails;
a second gear box hinged to the second tilting link and configured to transmit the rotational force to the second tilting link;
a second lead screw inserted into and coupled to the second gear box in the forward-and-rearward direction so as to move the second gear box forwards and rearwards, wherein the second lead screw has a rear end hinged to the connection frame configured to connect the pair of seat rails; and
a double-shaft motor connected to the first gear box and the second gear box so as to transmit the rotational force to the first gear box and the second gear box.

3. The vehicle seat position adjustment device of claim 2, further comprising:
a first front link having one end hinged to the first tilting link and another end hinged to a first front end of the seat cushion frame; and
a second front link having one end hinged to the second tilting link and another end hinged to a second front end of the seat cushion frame.

4. The vehicle seat position adjustment device of claim 3, wherein the first tilting link has a 1-1 hinge end formed at an upper end thereof and hinged to the first gear box, a 1-2 hinge end formed at a front end thereof and hinged to the first front link, and a 1-3 hinge end formed at a lower end thereof and hinged to the first fixing bracket.

5. The vehicle seat position adjustment device of claim 3, wherein the second tilting link has a 2-1 hinge end formed at an upper end thereof and hinged to the second gear box, a 2-2 hinge end formed at a front end thereof and hinged to the second front link, and a 2-3 hinge end formed at a lower end thereof and hinged to the second fixing bracket.

6. The vehicle seat position adjustment device of claim 2, wherein the first lead screw passing through the first gear box and the second lead screw passing through the second gear box have stopper nuts respectively coupled to front ends thereof, wherein each of the stopper nuts limits a maximum forward distance of the first gear box and the second gear box.

7. The vehicle seat position adjustment device of claim 2, wherein the double-shaft motor has a support plate mounted thereon, wherein the support plate is connected to the first gear box and the second gear box and supports the double-shaft motor.

8. The vehicle seat position adjustment device of claim 7, wherein the first gear box has a first cover bracket mounted on a circumferential portion thereof, wherein the first cover bracket comprises an outer plate hinged to an upper end of the first tilting link and a connection end coupled to one end of the support plate.

9. The vehicle seat position adjustment device of claim 7, wherein the second gear box has a second cover bracket mounted on a circumferential portion thereof, wherein the second cover bracket comprises an outer plate hinged to an upper end of the second tilting link and a connection end coupled to another end of the support plate.

10. The vehicle seat position adjustment device of claim 2, wherein the connection frame has hinge brackets mounted thereon and respectively hinged to the rear end of the first lead screw and the rear end of the second lead screw.

11. The vehicle seat position adjustment device of claim 2, wherein a flexible cable is adopted for a first rotation transmission shaft and a second rotation transmission shaft, wherein the first rotation transmission shaft connects one output part of the double-shaft motor to an input part of the first gear box, and the second rotation transmission shaft connects the other output part of the double-shaft motor to an input part of the second gear box.

12. The vehicle seat position adjustment device of claim 1, further comprising:
first and second height adjustment links having upper ends respectively hinged to opposite rear ends of the seat cushion frame and lower ends respectively hinged to opposite rear ends of the side frames;
a sector gear formed at a front portion of the upper end of the first height adjustment link;
a height adjustment motor mounted on one rear end of the seat cushion frame; and
a pinion mounted on an output shaft of the height adjustment motor and engaged with the sector gear.

13. The vehicle seat position adjustment device of claim 11, wherein the first height adjustment link has a curved slot formed at an upper portion thereof and formed to penetrate the upper portion, wherein the curved slot limits a lifting distance of the seat cushion frame, and the seat cushion frame has a guidance pin formed to protrude from the one rear end thereof and movably inserted into the curved slot.

14. A vehicle seat comprising the vehicle seat adjustment device of claim 1.

15. A vehicle comprising the vehicle seat adjustment device of claim 1.

16. A method of operating a vehicle seat position adjustment device, the method comprising:
providing a vehicle seat position adjustment device comprising:
a first fixing bracket and a second fixing bracket respectively mounted on front ends of a pair of seat rails;
a seat cushion frame hinged to side frames respectively mounted on rear ends of the seat rails;
a tilting link comprising a first tilting link hinged to the first fixing bracket and a second tilting link hinged to the second fixing bracket; and
a driving device connected to the first tilting link and the second tilting link and configured to transmit, to the first tilting link and the second tilting link, rotational force to tilt the seat cushion frame;
performing a tilting operation of a seat cushion by rotating a tilting link hinged to a gear box in a standing direction of the tilting link while the gear box is moved rearwards along a lead screw;
pushing up a front link hinged to the tilting link while the tilting link is rotated in the standing direction, and
allowing the front link to push up a front end of the seat cushion frame.
